(19) United States
(12) Patent Application Publication
(10) Pub. No.: US 2025/0058671 A1
(43) Pub. Date: Feb. 20, 2025

(54) Interchangeable Battery System

(71) Applicants: Nicholas Planson, New Gloucester, ME (US); Nathaniel VerLee, New Gloucester, ME (US)

(72) Inventors: Nicholas Planson, New Gloucester, ME (US); Nathaniel VerLee, New Gloucester, ME (US)

(21) Appl. No.: 18/452,337

(22) Filed: Aug. 18, 2023

(51) Int. Cl. B60L 53/80; B60L 53/62; H01M 10/48; H01M 50/244; H01M 50/249; H01M 50/256; H01M 50/298

(52) U.S. Cl. CPC B60L 53/80; B60L 53/62; H01M 10/486; H01M 50/244; H01M 50/249; H01M 50/256; H01M 50/298

(57) ABSTRACT

The present disclosure relates to an interchangeable battery system for electric vehicles. The system comprises a battery with a main body, electronic housing, and mounting feet, along with a common plug. The battery is connected to a motor controller by the common plug, which facilitates the flow of electricity from the battery to a motor. The battery system offers convenient replacement and recharging options. Different mounting options and a secure common plug connection enable the battery to be easily transferred between a range of small electric vehicles.

### BACKGROUND

The present disclosure relates generally to an interchangeable battery system. More particularly, the present disclosure relates to a battery system, which includes a battery and a common plug for connecting the battery to different motors for a variety of electric vehicles.

In recent years, electric vehicles have gained significant attention as an environmentally friendly alternative to traditional fuel-powered vehicles. However, one of the challenges in the electric vehicle industry is the cost and limited interchangeability of batteries across different types of small electric vehicles, such as boats, snowmobiles, and golf carts. Currently, each electric vehicle has its own unique battery design, making it difficult and expensive to share batteries among different types of vehicles.

In addition to the problem of limited interchangeability among batteries for small electric vehicles, there are several other challenges associated with electric vehicle batteries. Some of these problems include limited range, long charging times, and high costs. Several approaches have been attempted to overcome these hurdles; however, the result of implementing any given approach is unpredictable due to the complexity of electric vehicle battery technology.

Therefore, what is needed is an interchangeable battery system for small electric vehicles having all the further described features and advantages.

### SUMMARY

The subject matter of this application may involve, in some cases, interrelated products, alternative solutions to a particular problem, and/or a plurality of different uses of a single system or article.

In one aspect, a battery system is disclosed. In this aspect, the system includes a battery, a motor, a motor controller, and a common plug. The battery has a main body, an electronic housing, and a carry handle, and the common plug facilitates the flow of electricity from the battery to the motor controlled by the motor controller.

In another aspect, a method of operating the battery system for interchangeable use in a number of different electric vehicles is disclosed. In this aspect, the method requires the step of providing the battery system, which includes the battery and the common plug. The method also requires an electrical connection to be established between the battery and a motor of a first vehicle using the common plug. The battery then supplies electrical energy to the motor through the common plug. The method then includes the steps of disconnecting the common plug from the motor of the first vehicle and establishing another electrical connection between the same battery and the motor of another vehicle using the common plug. The common plug facilitates the supplying of electrical energy from the battery to the second vehicle.

### BRIEF DESCRIPTION OF THE DRAWINGS

FIG. 1 provides a diagrammatic representation of one embodiment of the interchangeable battery system.

FIG. 2 provides a perspective view of one embodiment of the battery.

FIG. 3 provides a diagrammatic representation of one embodiment of the internal electronics for the battery.

FIG. 4a provides a perspective view of one embodiment of a mounting mechanism for the battery.

FIG. 4b provides a perspective view of another embodiment of a mounting mechanism for the battery.

FIG. 4c provides a perspective view of yet another embodiment of a mounting mechanism for the battery.

FIG. 4d provides a cross sectional perspective view of one embodiment of an enclosure for the battery.

FIG. 5 provides a cross sectional perspective view of one embodiment of a slide mounting mechanism for the battery.

FIG. 6a provides a perspective view of one embodiment of the common plug.

FIG. 6b provides another perspective view of one embodiment of the common plug.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and/or the sequence of in steps for constructing and operating the invention connection with the illustrated embodiments.

Generally, the present disclosure concerns an interchangeable battery system that may provide versatile functionality and ease of use in various applications. In most embodiments, the system architecture may comprise several key components, including a battery, a common plug, a motor controller, and a motor. These features may enable the battery to be seamlessly used and transferred between various electric vehicles.

In one embodiment, the battery may be specifically designed to facilitate easy transfer and compatibility between different vehicles. The battery may include one or more carry handles, which may be strategically positioned for convenient lifting and handling. Furthermore, the battery may or may not comprise one or more mounting feet. The mounting feet may allow the battery to be mounted inside different vehicles having different internal designs and mounting mechanisms. For example, an embodiment of the battery with one or more mounting feet may be secured inside vehicles using bolt-down, clamp-down, or drop-in mechanisms. Similarly, embodiments of the battery with or without mounting feet may be securely placed within an insulated nest enclosure. These different mounting mechanisms may ensure secure placement of the battery while offering flexibility and ease of installation.

In one embodiment, the battery may incorporate one or more electrical ports, which may enable seamless connection to the electrical components of different devices or vehicles, including, but not limited to, different motors and motor controllers. The internal electronics of the battery may support efficient power distribution and communication. Particularly, in one embodiment, these electronics may include a pilot line, data line, high power line, and low power line.

The data line may enable data transmission that may be supported on or readable using a network. In a preferred embodiment, the network is the Can Bus network. The pilot line may utilize an AUX 12 V power supply and may incorporate additional features such as a moisture sensing wire, pre-plug, post-plug, and an ID chip, which may enable enhanced control and monitoring capabilities. The high power line and low power line may both support a voltage range of 48 V to 96 V, with the high power line being capable of carrying currents up to 180 A, while the low power line may be limited no more than 30 A. These power lines may play a critical role in efficient power transfer to meet the specific requirements of different applications.

As will be appreciated by those skilled in the art, the external and internal components of the presently disclosed battery system primarily address the problem of battery interchangeability for small electric vehicles. While battery swapping has been explored as a potential solution for larger electric vehicles, like cars, there are multiple impracticalities with and there is not as great a need for battery interchangeability in this context. For example, battery packs for sedans, minivans, sport utility vehicles, and the like are usually significantly larger and heavier than those used in small electric vehicles, making the them more cumbersome and process of physically swapping time-consuming. As a result, the infrastructure required to support battery swapping at scale for electric cars is complex and costly to implement. Additionally, the charging infrastructure for electric cars has been rapidly expanding, with a growing network of stations of charging stations providing convenient and efficient charging solutions, which has greatly reduced the need for battery swapping in the context of large electric vehicles. Accordingly, in a preferred embodiment, the vehicle that houses the interchangeable battery is a light electric vehicle and not an electric car or a larger vehicle.

While the presently disclosed battery system may be most advantageously used to power smaller electric vehicles, this does not diminish the complexity of the system or the unpredictability of the results of its implementation. For example, in one embodiment, the interchangeable battery may include a non-transitory computer readable medium having instructions allowing and instructing a processor to carry out the steps of a method that may be required during operation of the system. The non-transitory computer readable medium and processor may be stored within an electronic housing of the battery, and the processor may regulate and control the power flow within the battery.

In one embodiment, the processor may be a microprocessor that is configured to monitor and control various parameters such as cell voltages, temperatures, and currents. The processor may receive inputs from sensors positioned near the battery cells, which may enable precise monitoring and regulation of the battery's performance. These sensors may include a temperature sensor, a voltage sensor, and the like, which may ensure optimal utilization of the battery's capabilities while maintaining safe operating conditions.

In one embodiment, the processor carries out the steps of a method for monitoring and controlling battery performance. This method may comprise the step of receiving inputs from various sensors located within the battery, including, acquiring and analyzing sensor data to assess the battery's state. The processor may compare the measured values against predefined thresholds or setpoints to determine whether the parameters are within acceptable ranges. For example, the processor may acquire and analyze sensor data and utilize one or more algorithms to compute parameters such as the battery's state of charge (“SOC”), state of health (“SOH”), and the like. Based on this acquisition, analysis, and comparison of sensor data, the processor may also control the flow of electrical energy within the battery by activating or deactivating electric switches. These switches may be responsible for controlling current flow through different paths, such as the high power and low power lines. By selectively activating or deactivating these switches, the processor may also regulate the flow of current and power within the battery system.

In one embodiment, a common plug may connect the battery to external devices or vehicles. The common plug may comprise a cable connected to a plug head, which may incorporate multiple pins for efficient connectivity. The cable may have a number of pilot, data, high power, and low power wires, each connected to respective pins on the plug head. To ensure durability and reliability, an exterior jacket may protect the wires within the cable. In one embodiment, the exterior jacket may have high abrasion resistance and UV resistance. The jacket may also be flexible at low temperatures to ensure efficient operation in diverse environmental conditions.

As will be appreciated by those skilled in the art, a method of operating a battery system for interchangeable use in multiple vehicles is also provided herein. The method involves several steps. For example, in a preferred embodiment, the first step of the method involves providing which comprises the battery and the the battery system, common plug. Then, a first electrical connection may be established between the battery and a motor of a first electric vehicle using the common plug. This may enable the flow of electrical energy to power the first motor from the battery through the common plug. The common plug may be disconnected from the first motor and subsequently connected to the motor of a second electric vehicle, establishing a second electrical connection.

In one embodiment where the battery includes one or more mounting feet and one or more carry handles, additional steps may be involved. For example, the battery may be initially secured to the first vehicle using at least one mounting foot. Then, to transfer the battery to the second vehicle, the battery may be disconnected from and lifted out of the first vehicle by gripping at least one carry handle. The battery may then be secured to the second vehicle using one or more mounting feet. The different mounting mechanisms described herein may be used to secure the battery to either vehicle. The battery may also be recharged before or during its use in the operation of either vehicle.

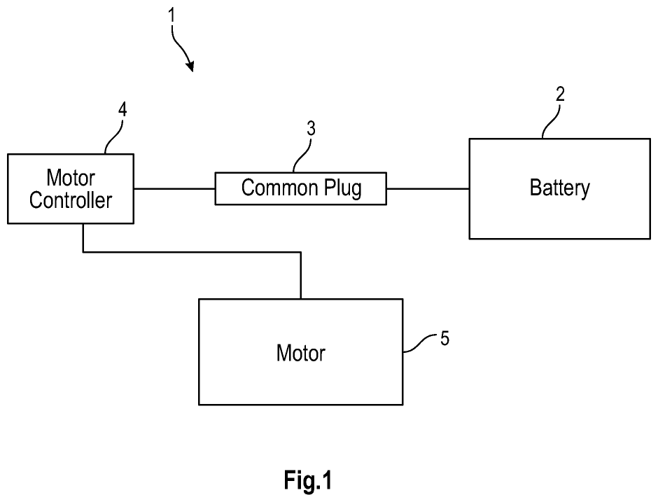

Turning now to FIG. 1, which illustrates an embodiment of the interchangeable battery system 1. The system comprises a battery 2 and a motor controller 4 connected by a common plug 3. This arrangement facilitates the flow of electricity from the battery 2 to the motor 5, enabling motor operation under the control of the motor controller 4. The battery 2 serves as the power source for the system 1 and can be attached to or detached from the common plug 3, allowing for convenient replacement or recharging when necessary. The common plug 3 is a connector that establishes an electrical connection between the battery 2, the motor controller 4, and the motor 5.

Upon establishing the electrical connection, the battery 2 supplies the necessary electrical energy to the motor controller 4. The motor controller 4, acting as a control unit, manages and regulates the electrical signals sent to the motor 5. This control enables the motor 5 to operate efficiently and facilitate various motor-driven motor 5, applications. The connected to the motor controller 4, translates the electrical signals received from the motor controller 4 into mechanical motion. This motion can be utilized to power a variety of different electric vehicles, including, but not limited to, snowmobiles, boats, race carts, tractors, and the like.

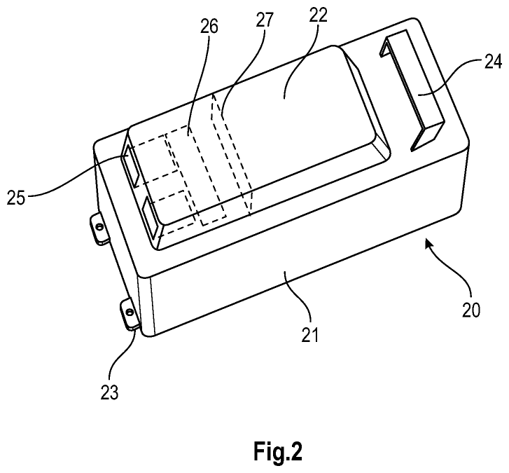

FIG. 2 provides a perspective view of one embodiment of the battery 20. The battery 20 features several key components, including a main body 21, an electronic housing 22, mounting feet 23, and a carry handle 24. The arrangement of these components ensures the functionality and convenience of the battery 20.

The main body 21 serves as the central structure of the battery 20 and accommodates various internal components. It provides structural integrity for the electronic housing 22 and other internal elements. Additionally, the main body 21 is equipped with mounting feet 23 on its bottom, enabling secure attachment to external surfaces or battery housings within multiple electric vehicles.

The electronic housing 22 and the carry handle 24 are positioned on top of the main body 21, offering ease of handling and portability. In this particular embodiment, still referring to FIG. 2, the carry handle 24 is located at a distal end of the electronic housing 22, providing a comfortable grip for users during when transferring the battery 20 between different applications, such as recharging and powering motors.

The electronic housing 22 defines at least one port 25 at its proximal end. The ports 25 are designed to connect to at least one common plug, facilitating electrical connections between the battery 20 and external devices such as motors or additional batteries. The common plug ensures a secure and reliable electrical interface, enabling the transfer of power or data.

Within the electronic housing 22, there are two distinct compartments: the connector bay 26 and the processing bay 27. The connector bay 26 is intended for housing connectors or terminals that establish electrical connections with external devices. These connectors allow for the transfer of electrical energy or signals to and from the battery 20. The processing bay 27 houses circuitry, control units, or electronic components responsible for monitoring and managing the battery's performance, including voltage regulation, power output control, and other necessary functions.

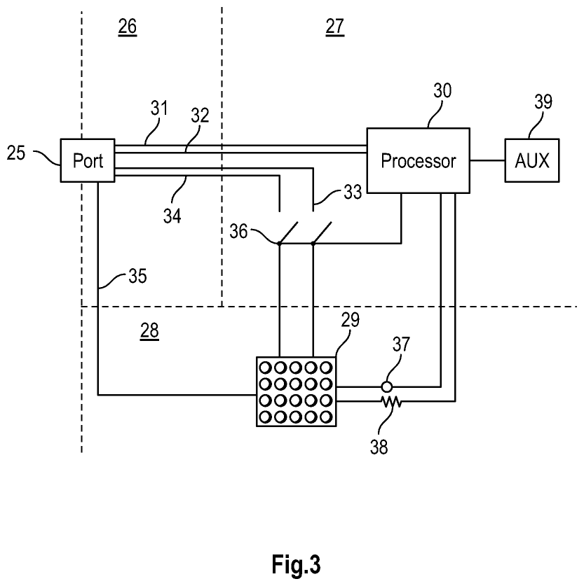

FIG. 3 presents a diagrammatic representation of the internal electronics of the battery, showcased as an electric circuit diagram for a single port 25. It should be noted that in alternative embodiments featuring two or more ports 25, the electronic circuitry would be replicated to match the number of ports.

In the embodiment shown in FIG. 3, the distal portion of the port 25 is situated within the connector bay 26, and the proximal portion is accessible from the exterior of the battery 20. The connector bay 26 serves as a connection point between the port 25 and the processing bay 27 located within the electronic housing 22, as well as the cell bay 28 situated within the main body 21 of the battery 20.

Within the cell bay 28, a power source 29 is housed. The power source 29 comprises a housing that encompasses multiple chemical cells specifically configured to deliver electrical power to the port 25. These chemical cells generate and store electrical energy, enabling the battery 20 to supply power to connected motors and also to be recharged.

The port 25 is also connected to a processor 30 housed within the processing bay 27. The processor 30 performs various control and management functions, ensuring the efficient operation and optimal performance of the battery. It governs activities such as voltage regulation, power output control, and monitoring the overall condition of the battery.

The electronic circuitry within the battery establishes electron flow paths, facilitating the transfer of electrical signals and power between the port 25, the processing bay 27, and the cell bay 28. These flow paths enable the exchange of electrical energy and data within the battery, supporting the overall functionality and operation of the entire system, including the common plug and motor elements.

The port 25 is equipped with multiple connections that serve the purpose of exchanging electrical energy and data. Two of these connections are the data line 31 and the pilot line 32, both of which establish a link to the processor 30. They enable the exchange of data and control signals, ensuring effective communication between the port 25 and the processor 30.

Additionally, there are two more connections: the high power line 33 and the low power line 34. These connections are responsible for establishing a connection between the port 25 and the power source 29. The high power line 33 is designed to handle higher levels of electrical power, while the low power line 34 is suited for lower power applications. Furthermore, the port 25 also shares a third common connection line 35 with the power source 29.

The switches 36, serving as electronic control devices, are directly linked to the processor 30. Through this connection, the processor 30 exercises precise control over the switches 36, thereby governing the flow of electrons from the power source 29 to the port 25 via the high power line 33 and the low power line 34.

By commanding the switches 36, the processor 30 can regulate the opening and closing of these electronic components at specific timings and under predetermined conditions. This control mechanism enables the processor 30 to modulate the power flow within the battery, adjusting it according to the requirements of the connected devices and ensuring optimal power management.

For instance, the processor 30 may activate or deactivate the switches 36 based on factors such as the power demand from the port 25, the overall system load, or specific operating conditions. By dynamically controlling the switches 36, the processor 30 optimizes the distribution of electrical energy, promoting efficient utilization and avoiding potential overloading or underutilization of the power source 29.

The processor 30 is also connected to a temperature sensor 37 and a cell voltage sensor 38, both of which are situated within the cell bay 28. The cell voltage sensor 38 provides the processor 30 with real-time information about the voltage levels of each individual cell or group of cells within the power source 29. By collecting this data, the sensor 38 enables the processor 30 to accurately assess the state of charge and health of the battery.

With information about the cell voltages, the processor 30 can accurately operate the switches 36. For example, if the cell voltage sensor 38 detects a significant imbalance in voltage levels among the cells, indicating a potential issue such as an undercharged or overcharged cell, the processor 30 can adjust the control signals to the switches 36 accordingly. It may activate specific switches to redistribute the load among cells, equalize the cell voltages, or activate protection mechanisms to prevent damage to the battery.

Similarly, the temperature sensor 37 provides the processor 30 with valuable temperature data from within the cell bay 28. It continuously monitors the temperature levels to ensure that they remain within safe operating limits. In situations where the temperature exceeds the predetermined thresholds, indicating potential overheating or other hazardous conditions, the temperature sensor 37 promptly notifies the processor 30.

In response, the processor 30 is then operable to take appropriate actions to safeguard the battery system. It may modify the control signals sent to the switches 36 to limit the power flow, activate cooling mechanisms, or initiate protective measures to prevent further temperature escalation the longevity and safety of the battery.

The processor 30 is also linked to auxiliary rails 39, which are located within the processing bay 27. This connection enables the processor 30 to interface with and control additional auxiliary components for the battery system, when necessary.

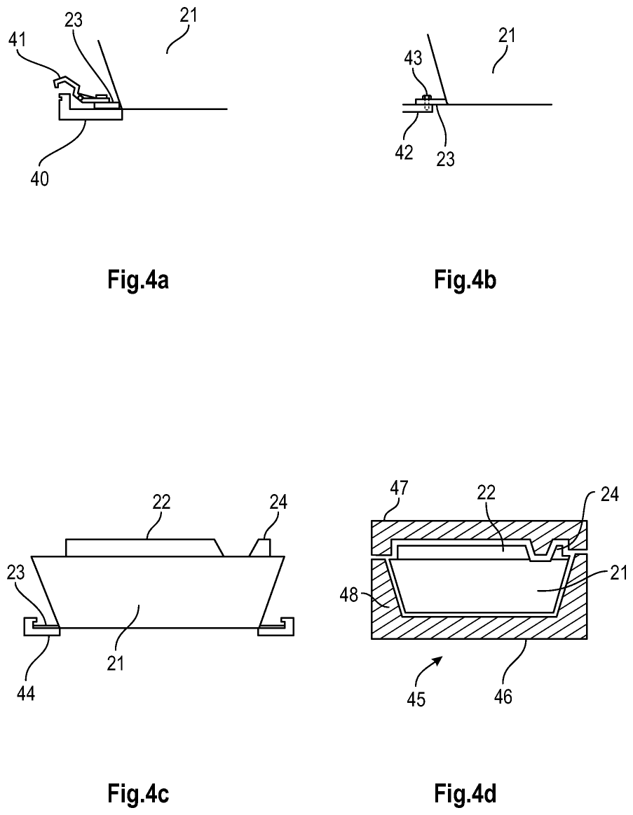

FIGS. 4a-4c present different mounting mechanisms for various embodiments of the battery 20, featuring the main body 21 and mounting feet 23. These mounting mechanisms provide versatility and flexibility for securely attaching the battery in different configurations.

In one embodiment depicted in FIG. 4a, the mounting foot 23 of the battery is affixed to an L-shaped mounting surface 40 using a clamp 41. FIG. 4b illustrates another mounting mechanism where the mounting foot 23 is fastened to a flat mounting surface 42 using a bolt 43. These methods offer secure and rigid attachments, providing stability and minimizing movement of the battery during operation.

In FIG. 4c, an alternative mounting approach is showcased. The main body 21 of the battery is elevated by lifting it from the carry handle 24 and placed onto the J-shaped receiving elements 44 of a drop-in nest. In this configuration, the electronic housing 22 and a significant portion of the main body 21 are positioned above the drop-in nest 44. This design facilitates convenient connection to ports located on either the electronic housing 22 or the main body 21 of the battery 20.

FIG. 4d provides a cross-sectional perspective view of an embodiment of an enclosed nest 45 designed to house a battery without mounting feet. In this embodiment, the main body 21 of the battery is placed into the receiving portion 46 of the enclosed nest 45 by gripping the carry handle 24 and moving the body 21 into position. The receiving portion 46 is specifically designed to securely hold and position the battery within the nest 45.

To safeguard the battery, a closing element 47 is employed. The closing element 47 is securely fastened over the open top of the enclosed nest 45, providing a protective enclosure for the main body 21 and the electronic housing 22 of the battery. This effectively shields the battery from external elements and potential damage.

To facilitate electrical connections, the electronic housing 22 is strategically positioned above the receiving portion 46, in proximity to the open top of the nest 45. This placement allows for convenient access to the necessary electrical ports and connectors on the battery.

Both the closing element 47 and the receiving portion 46 of the enclosed nest 45 incorporate insulation 48. The insulation 48 serves as an additional layer of protection for the battery, guarding against potential electrical or thermal hazards and enhancing overall safety.

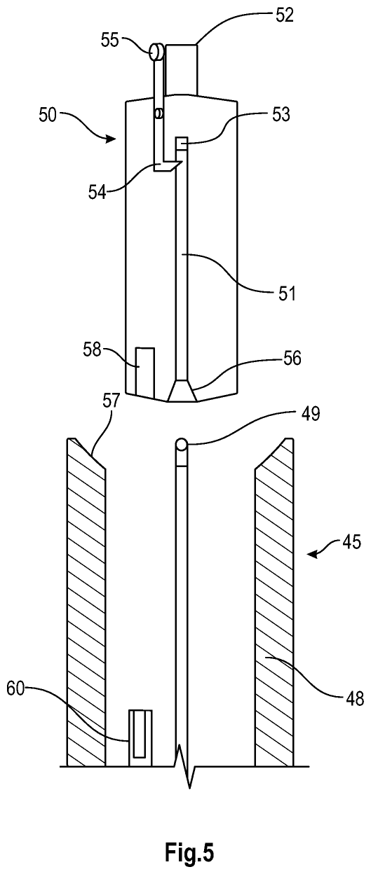

FIG. 5 presents a cross-sectional perspective view of a slide mounting mechanism for one embodiment of the battery 50. This mounting mechanism includes a battery nest 45 with insulation 48, along with a slide rail 49 situated within the nest 45. The battery 50 defines a slide channel 51 traversing its body, capable of accommodating the slide rail 49, thereby facilitating mounting the battery 50 within the nest 45.

To mount the battery 50 within the nest 45, a user grips the carry handle 52 and lifts the battery 50, aligning it over the slide rail 49. The slide channel 51 is equipped with an end stop 53 at its distal end, preventing the battery 50 from sliding further into the nest 45. Moreover, a latch point 54 positioned inside the battery 50 secures the slide rail 49 in place, effectively preventing inadvertent removal of the battery from the nest 45.

To disengage the battery 50 from the slide rail 49, an interior latch point 54 is connected to a latch release 55 on the battery's exterior. The latch release 55 is located near the carry handle 52, which allows allows for simple and efficient detachment of the battery 50 when needed.

The battery 50 also features an alignment guide 56 at the proximal end of the slide channel 51. In this embodiment, the alignment guide 56 is an aperture wider than the slide channel 51, allowing the battery 50 to be installed in the nest 45 at various angles, ranging from 0 to 90 degrees. The top walls of the nest 45 may also incorporate a bevel 57, which complements the alignment guide 56, facilitating the installation of the battery 50 at sharp angles.

When properly installed, the plug receptacle 58 of the battery 50 aligns precisely with the built-in common plug 60 at the bottom of the nest 45, establishing a secure electrical connection between the battery 50 and the vehicle or device it powers.

The different mounting mechanisms illustrated in FIGS. 4a-4d and FIG. 5 demonstrate the adaptability of the interchangeable battery system. These variations in mounting enable the battery to be securely installed in diverse scenarios, accommodating different vehicle configurations and installation requirements. The precise mounting method utilized depends on factors such as the vehicle design, available space, desired accessibility, and the overall intended functionality of the system.

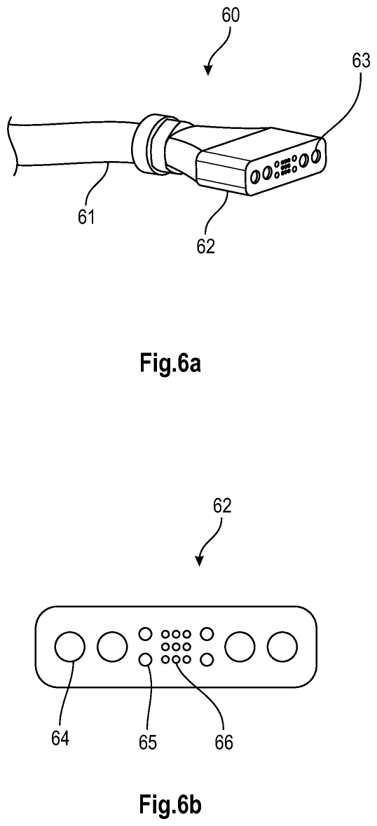

FIGS. 6a and 6b provide different perspective views of an embodiment of the common plug 60. As illustrated by the perspective in FIG. 6a, the common plug 60 consists of a cable 61 connected to a plug head 62. The exterior jacket of the cable 61 provides protection to the internal insulation and wires within the plug 60. The plug head 62, positioned at the end of the common plug 60, comprises several connector pins 63, which serve as the interface for electrical connections and data transfer.

FIG. 6b shows the front face of the plug head 62 and provides a more detailed view of the connector pins 63. The connector pins 63 are categorized into three distinct types: high power pins 64, lower power pins 65, and data and pilot pins 66. The high power pins 64 are specifically designed to handle high power transfer between the common plug 60 and the connected battery or motor. The low power pins 65 are dedicated to transmitting and receiving lower levels of electrical power compared to the high power pins 64. The data and pilot pins 66 are responsible for carrying data and pilot signals. Data pins allow for the transmission of digital or analog data, and pilot pins are utilized for control, monitoring, or signaling purposes, providing essential feedback or initiating specific actions within the system.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A battery system comprising:
a battery comprising a main body, an electronic housing, and a carry handle;
a motor comprising a motor controller; and
a common plug connecting the battery to the motor controller;
wherein the common plug facilitates a flow of electricity from the battery to the motor controlled by the motor controller.

2. The battery system of claim 1 wherein the battery further comprises a mounting foot located on a bottom of the main body.

3. The battery system of claim 1 wherein the electronic housing and the carry handle are located on a top of the main body.

4. The battery system of claim 1 wherein the electronic housing defines a port configured to connect to the common plug.

5. The battery system of 1 wherein the electronic housing comprises a connector bay and a processing bay.

6. The battery system of claim 5 wherein the connector bay comprises a plurality of connectors that facilitate the flow of electricity.

7. The battery system of claim 6 wherein the plurality of connectors connect to a plurality of electrical lines, the plurality of electrical lines comprising a data line, a pilot line, high power line, and a low power line.

8. The battery system of claim 5 wherein the processing bay comprises a processor and a plurality of switches, the processor connected to the plurality of switches.

9. The battery system of claim 8 wherein the switches control a flow of electricity from a high power line and a low power line connected to a port.

10. The battery system of claim 8 wherein the processor is connected to a plurality of auxiliary rails.

11. The battery system of claim 1 wherein the main body comprises a cell bay.

12. The battery system of claim 11 wherein the cell bay comprises a power source, a temperature sensor, and a voltage sensor.

13. The battery system of claim 1 wherein the common plug comprises a cable connected to a plug head.

14. The battery system of claim 13 further comprising a plurality of connector pins located on a front face of the plug head.

15. The battery system of claim 14 wherein the plurality of connector pins comprise a high power pin, a low power pin, a data pin, and a pilot pin.

16. A method of operating a battery system for interchangeable use in a plurality of different vehicles, comprising:
providing the battery system comprising a battery and a common plug;
establishing a first electrical connection between the battery and a motor of a first vehicle using the common plug;
supplying electrical energy from the battery to the motor of the first vehicle through the common plug;
disconnecting the common plug from the motor of the first vehicle;
establishing a second electrical connection between the battery and a motor of a second vehicle using the common plug; and
supplying electrical energy from the battery to the motor of the second vehicle through the common plug.

17. The method of claim 16 wherein the battery comprises a mounting foot and a carry handle, the method further comprising:
securing the battery to the first vehicle using the mounting foot;
disconnecting the battery from the first vehicle and lifting the battery out of the first vehicle by gripping the carry handle;
transferring the battery to the second vehicle; and
securing the battery to the second vehicle using the mounting foot.

18. The method of claim 17 further comprising a mounting mechanism for securing the battery to at least one of the first vehicle or second vehicle, the mounting mechanism comprising a mounting surface and at least one of a clamp or a screw connecting the mounting foot to the mounting surface.

19. The method of claim 16 wherein the battery comprises a plurality of mounting feet and a carry handle, the method further comprising:
placing the battery into a plurality of receiving elements for a drop-in nest inside the first vehicle using the mounting feet;
removing the battery from the first vehicle by gripping the carry handle, sliding the mounting feet out of the plurality of receiving elements, and lifting the battery; and
securing the battery to the second vehicle using the mounting feet.

20. The method of claim 16 further comprising:
placing the battery within a receiving portion of an insulated nest of the first vehicle; and
securing a closing element of the insulated nest over a top of the battery.
